(19) United States
(12) Patent Application Publication
(10) Pub. No.: US 2005/0264923 A1
(43) Pub. Date: Dec. 1, 2005

(54) Disk drive

(75) Inventors: Akihiro Kimura, Akishima-shi (JP); Kazuhito Shimomura, Fussa-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 11/057,901

(22) Filed: Feb. 14, 2005

(30) Foreign Application Priority Data
May 28, 2004 (JP) 2004-159717

(51) Int. Cl. G11B 17/00

(52) U.S. Cl. 360/97.01

(57) ABSTRACT

A disk drive includes a case which contains a disk-shaped recording medium, drive motor, head, and head actuator. The drive motor supports and rotates the recording medium. The head processes information for the recording medium. The head actuator supports the head for movement and moves the head with respect to the recording medium. A control circuit board is mounted to the outer surface of the case. The control circuit board has a plurality of connector pads for connection with external equipment. The connector pads are arranged side by side and exposed on the outer surface of the control circuit board. The connector pads are positioned on a side of the control circuit board adjacent the head actuator.

### CROSS-REFERENCE TO RELATED APPLICATIONS

This application is based upon and claims the benefit of priority from prior Japanese Patent Application No. 2004-159717, filed May 28, 2004, the entire contents of which are incorporated herein by reference.

### BACKGROUND OF THE INVENTION

1. Field of the Invention

This invention relates to a disk drive having a disk for use as a recording medium.

2. Description of the Related Art

In recent years, disk drives, such as magnetic disk drives, optical disk drives, etc., have been widely used as external recording devices of computers and image recording devices.

A magnetic disk drive as an example of a disk drive usually has a case in the form of a rectangular box. The case contains a magnetic disk for use as a magnetic recording medium, a spindle motor, a plurality of magnetic heads, and a head actuator. The spindle motor serves as drive means that supports and rotates the disk. The magnetic heads are used to write and read information to and from the disk. The head actuator supports the magnetic heads for movement with respect to the magnetic disk. The case contains a voice coil motor, a substrate unit, etc. The voice coil motor rotates and positions the head actuator. The substrate unit has a head IC and the like.

A printed circuit board is screwed to the outer surface of the case. It controls the operations of the spindle motor, voice coil motor, and magnetic heads through the substrate unit. An interface (I/F) connector that connects the magnetic disk drive to external equipment is jointed to an end portion of the printed circuit board.

Described in Jpn. Pat. Appln. KOKAI Publication No. 2001-210058, for example, is a magnetic disk drive that has the form of a thin card such that it can be loaded into a card slot of a personal computer, for example. This card-type magnetic disk drive must be made thinner and smaller than a conventional magnetic disk drive. To attain this, various components are mounted on a sheetlike base, a support frame is fixed along the peripheral edge of the base, and a sheetlike top cover is attached to the support frame. Further, a printed circuit board is provided on the backside of the base, and an I/F connector on the circuit board is positioned and held with a dedicated fixing member that is attached to the support frame.

Recently, further miniaturization of magnetic disk drives has been advanced to use them as recording devices for a wider variety of electronic apparatuses, especially for smaller-sized electronic apparatuses. In a magnetic disk drive with a disk diameter of one inch or more, for example, the area of a printed circuit board that is located overlapping the surface of a case can be made smaller than the surface area of the case. In a magnetic disk drive with a disk diameter less than one inch, however, the printed circuit board must be lessened in size to cope with the miniaturization of the case. Accordingly, a setting space on the circuit board is so narrow that a plurality of electronic components cannot be mounted with ease. The connector that connects the magnetic disk drive to external equipment is relatively tall and bulky, in particular. Therefore, it cannot be easily mounted on the printed circuit board and constitutes a hindrance to the reduction of the overall thickness of the magnetic disk drive including the circuit board.

### BRIEF SUMMARY OF THE INVENTION

In accordance with an embodiment of the invention, there is provided a disk drive which contains a disk-shaped recording medium, drive motor, head, and head actuator. The drive motor supports and rotates the recording medium. The head processes information for the recording medium. The head actuator supports the head for movement and moves the head with respect to the recording medium. A control circuit board is mounted to the outer surface of the case. The control circuit board has a plurality of connector pads for connection with external equipment. The connector pads are arranged side by side and exposed on the outer surface of the control circuit board. The connector pads are positioned on a side of the control circuit board adjacent the head actuator.

In accordance with other embodiments of the invention, there is provided a disk drive comprising: a case in the form of a rectangular box; a disk-shaped recording medium located in the case; a drive motor which is located in the case and supports and rotates the recording medium; a head which processes information for the recording medium; a head actuator which is disposed in the case, supports the head for movement, and moves the head with respect to the recording medium; a substrate unit disposed in the case and connected to the head actuator; and a control circuit board opposed to the outer surface of the case and connected to the substrate unit, the control circuit board having a plurality of connector pads for connection with external equipment, the connector pads being arranged side by side and exposed on the outer surface of the control circuit board. The connector pads are positioned on a side of the control circuit board adjacent the head actuator.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred to as an HDD) according to a first embodiment of the Invention;

FIG. 2 is an exploded perspective view of the HDD;

FIG. 3 is a plan view showing a case and the internal structure of the HDD;

FIG. 4 is a perspective view showing the control circuit board side of the HDD;

FIG. 5 is a sectional view of the HDD taken along line V-V of FIG. 1;

FIG. 6 is a plan view showing a control circuit board of the HDD;

FIG. 7 is a plan view showing a control circuit board of an HDD according to a second embodiment of the invention;

FIG. 8 is a perspective view showing an HDD according to a third embodiment of the invention; and

FIG. 9 is a plan view showing a control circuit board of the HDD of the third embodiment.

### DETAILED DESCRIPTION OF THE INVENTION

An HDD according to an embodiment of this invention will now be described in detail with reference to the accompanying drawings.

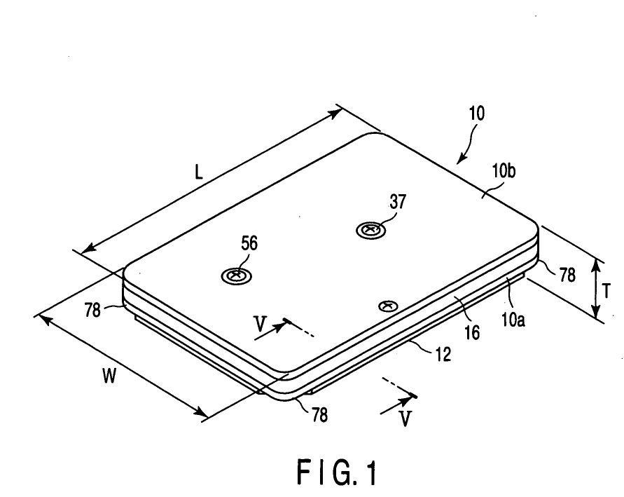

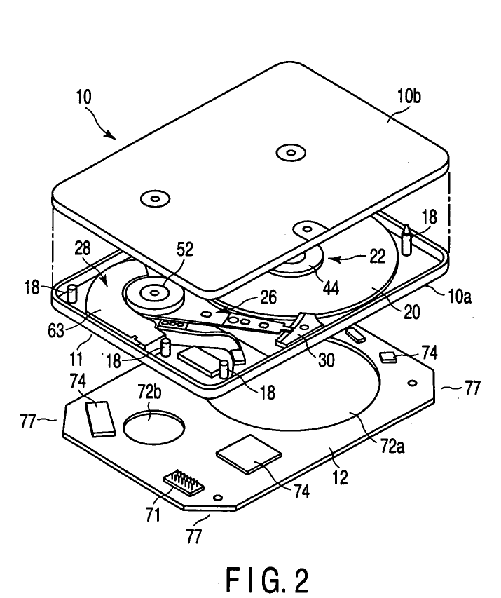

As shown in FIGS. 1 and 2, an HDD comprises a case 10 in the form of a substantially rectangular box and a rectangular control circuit board 12. The case 10 contains various members including a disk drive mechanism, which will be mentioned later. The control circuit board 12 is lapped on the outer surface of the case 10. The case 10 and the board 12 have, for example, a length L of 32 mm and a width W of 24 mm each and form a total thickness T of 3 to 6 mm. The thickness T is adjusted to, for example, about 3.3 mm or 5 mm, depending on the number of disks to be stored in the HDD.

As shown in FIGS. 2 and 5, the case 10 has ha first shell 10a and a second shell 10b that are substantially equal in size. The first and second shells 10a and 10b are opposed to each other with their respective peripheral edge portions facing each other. A belt-shaped seal member 16 is wound around the respective peripheral edge portions of the shells 10a and 10b, whereby the peripheral edge portions are connected to each other, and a gap between them is sealed by the seal member. These elements constitute the case 10 in the form of a rectangular box.

The bottom surface of the first shell 10a forms a rectangular mounting surface 11. The four corners of the case 10, including the corners of the mounting surface 11, are rounded like circular arcs. Thus, the seal member 16 that is wound around the peripheral edge portion of the case 10 is prevented from being damaged by the corners of the case, and lowering of airtightness by lifting of the seal member can be avoided.

Inside the case 10, a plurality of support posts 18 are provided on the peripheral edge portion of the case. Each support post 18 has a proximal end fixed on the inner surface of the first shell 10a and is set substantially upright on the inner surface.

The mounting surface 11 is formed having tapped holes corresponding individually to the posts 18 in position and extending into their corresponding posts.

The case 10 contains a magnetic disk 20 for use as an information recording medium, a spindle motor 22, a magnetic head 24, and a carriage 26. The disk 20 has a diameter of 0.85 inches, for example.

The spindle motor 22 serving as a drive motor supports and rotates the disk 20. The magnetic head 24 is used to write and read information to and from the disk 20. The carriage 26 supports the magnetic head 24 for movement with respect to the magnetic disk 20.

Further, the case 10 contains a voice coil motor (hereinafter referred to as VCM) 28, a ramp load mechanism 30, a solenoid latch 32, a substrate unit 34, etc. The VCM 28 rotates and positions the carriage. The ramp load mechanism 30 unloads and holds the magnetic head in a position off the magnetic disk 20 when the magnetic head 24 is moved to the peripheral edge portion of the disk. The latch 32 holds the carriage 26 in a retreated position. The substrate unit 34 has a head IC and the like.

The spindle motor 22 is mounted on the first shell 10a. It has a pivot 36, which is fixed and set substantially perpendicular to the inner surface of the case 10. An extended end of the pivot 36 is fastened to the second shell 10b with a fixing screw is 37 that is screwed into the second shell from the outside. Thus, the pivot 36 is supported by the first and second shells 10a and 10b from both sides.

A rotor is rotatably supported on the pivot 36 by a bearing (not shown). The end portion of the rotor on the side of the second shell 10b constitutes a hub 43, and the magnetic disk 20 is coaxially fitted on the hub. An annular clamp ring 44 is fitted on an end portion of the hub 43 and holds the circular peripheral edge portion of the magnetic disk 20.

Thus, the disk 20 is fixed to the rotor and supported so as to be rotatable integrally with the rotor.

An annular permanent magnet (not shown) is fixed to the end portion of the rotor on the side of the first shell 10a and situated coaxially with the rotor. The spindle motor 22 has a stator core attached to the first shell 10a and a plurality of coils wound around the stator core. The stator core and the coils are arranged outside the permanent magnet with a gap between them.

The carriage 26, which constitutes a head actuator, is provided with a bearing assembly 52 that is fixed on the inner surface of the first shell 10a. The bearing assembly 52 has a pivot 53 and a cylindrical hub 54. The pivot 53 is set on the inner surface of the first shell 10a substantially perpendicular thereto. The hub 54 is rotatably supported on the pivot 53 by a pair of bearings.

An extended end of the pivot 53 is fastened to the second shell 10b with a fixing screw 56 that is screwed into the second shell from the outside. Thus, the pivot 53 is supported by the first and second shells 10a and 10b from both sides. The bearing assembly 52, which serves as a bearing portion, is arranged side by side in the longitudinal direction of the case 10 with the spindle motor 22.

The carriage 26 comprises an arm 58 that extends from the hub 54, a suspension 60 in the form of an elongated sheet that extends from the distal end of the arm, and a support frame 62 that extends from the hub 54 in the direction opposite from the arm. The magnetic head 24 is supported on an extended end of the suspension 60 by a gimbals portion (not shown). The spring force of the suspension 60 causes the magnetic head 24 to apply a given head load toward the surface of the magnetic disk 20. A voice coil 64 that constitutes the VCM 28 is fixed integrally on the support frame 62.

The VCM 28, which rotates the carriage 26 around the bearing assembly 52, comprises a pair of yokes 63 and a magnet (not shown). The yokes 63 are fitted on the first shell 10a and opposed to each other across a gap. The magnet is fixed on the inner surface of one of the yokes and opposed to the voice coil 64.

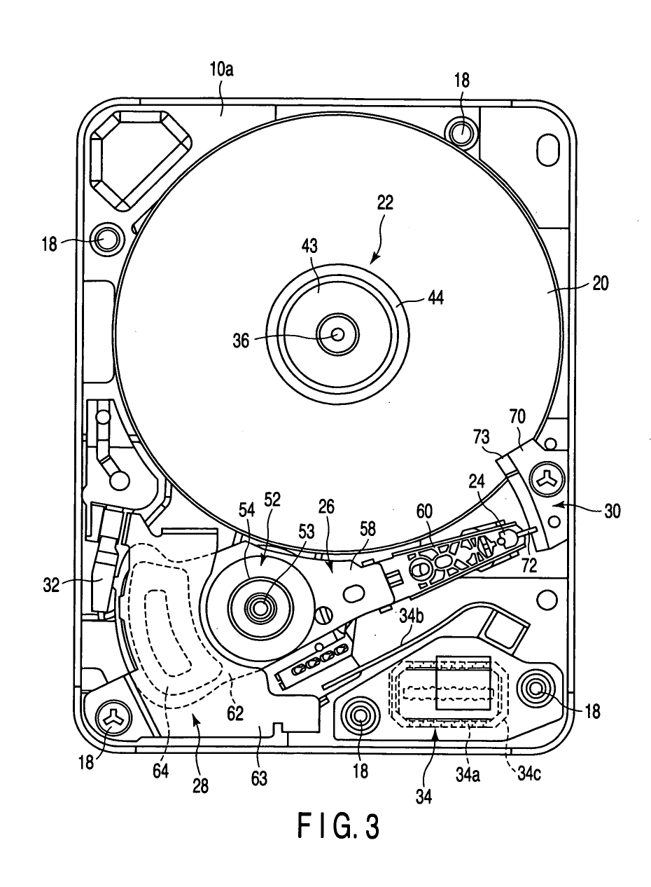

When the voice coil 64 is energized, the carriage 26 rotates between the retreated position shown in FIG. 3 and an operating position in which it is situated on the surface of the magnetic disk 20. Thereupon, the magnetic head 24 is positioned on a desired track of the disk 20. The solenoid latch 32 fixed on the first shell 10a latches the carriage 26 that is moved to the retreated position. It prevents the carriage 26 from moving from the retreated position to the operating position if the HDD is subjected to a shock or any other external force.

The ramp load mechanism 30 comprises a ramp member 70 and a tab 72. The ramp member 70 is fixed on the inner surface of the first shell 10a and opposed to the peripheral edge portion of the magnetic disk 20. The tab 72 extends from the distal end of the suspension 60 and serves as an engaging member. The ramp member 70 is formed by bending a sheet and has a ramp surface 73 that can be engaged by the tab 72. When the carriage 26 rotates from the inner peripheral portion of the magnetic disk 20 to the retreated position outside the disk, the tab 72 engages the ramp surface 73 of the ramp member 70. Thereafter, the tab 72 is pulled up by the inclination of the ramp surface, and the magnetic head 24 is unloaded. When the carriage 26 is rotated to the retreated position, the tab 72 is supported on the ramp surface 73 of the ramp member 70, and the magnetic head 24 is kept apart from the surface of the magnetic disk 20.

The substrate unit 34 has a body 34a that is formed of a flexible printed circuit board and fixed on the inner surface of the first shell 10a. Electronic components, such as the head IC, a head amplifier, etc., are mounted on the body 34a. The substrate unit 34 has a main flexible printed circuit board (hereinafter referred to as main FPC) 34b that extends from the body 34a. An extended end of the main FPC 34b is connected close to the bearing assembly 52 of the carriage 26 and also connected electrically to the magnetic head 24 by a cable (not shown) that overlies the arm 58 and the suspension 60. A connector 34c for connection with the control circuit board 12 is mounted on the bottom surface of the body of the substrate unit 34. The connector 34c is exposed to the mounting surface 11 of the first shell 10a through an opening in the first shell.

As shown in FIGS. 2, 4 and 5, the control circuit board 12, which is formed of a printed circuit board, has the shape of a rectangle that is substantially equal in length and width to the mounting surface 11 of the case 10. The mounting surface 11 of the case 10 is formed having a circular protrusion 70a corresponding to the spindle motor 22 and a circular protrusion 70b corresponding to the bearing assembly 52. The control circuit board 12 has circular openings 72a and 72b that correspond to the protrusions 70a and 70b, respectively. Four corner portions of the control circuit board 12 are obliquely cut at angles of 45 degrees to the individual sides, for example, thereby forming notch portions 77, individually. A plurality of electronic components 74 and a connector 71 are mounted on the inner surface of the control circuit board 12 that faces the case 10.

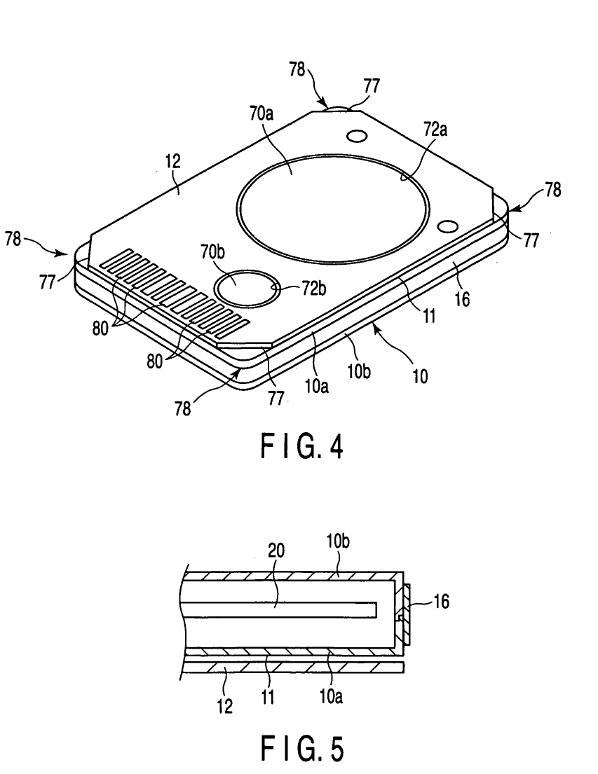

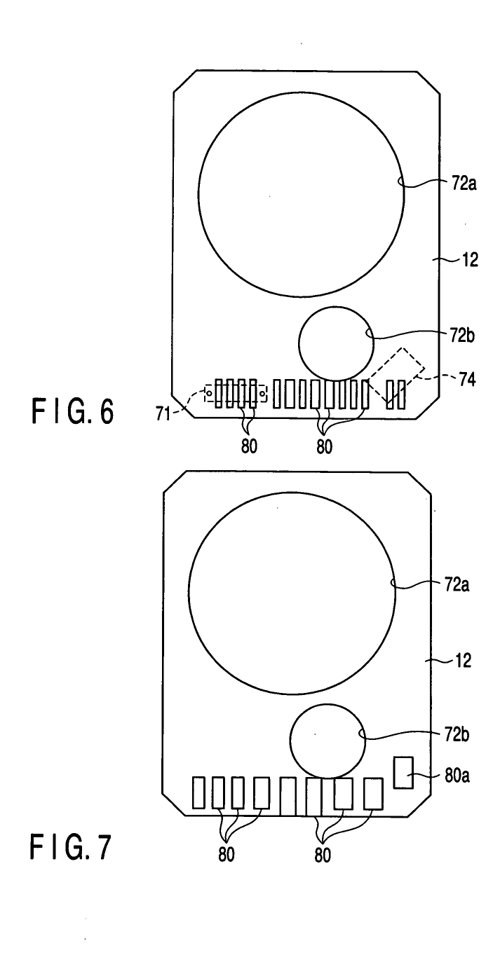

As shown in FIGS. 4 and 6, a plurality of connector pads 80, e.g., 14 in number, for electrical connection between the HDD and external equipment are located exposed on the outer surface of the control circuit board 12. The pads 80 are arranged side by side near and along one side of the board 12. In the present embodiment, the pads 80 are arranged along that short side of the board 12 which is situated on the side of the bearing assembly 52. Each connector pad 80 is in the form of an elongated rectangle that extends in the longitudinal direction of the control circuit board 12. The connector pads 80 are spaced from one another and substantially cover the whole length of the short side portion of the board 12. The connector 71 and at least one of the electronic components 74 that are mounted on the inner surface of the board 12 are situated in the board 12 on the opposite side of the board 12 from the connector pads 80.

The control circuit board 12 formed in this manner is superposed on the mounting surface 11 of the case 10 and fastened to the first shell 10a with screws. The board 12 is thus located in a manner such that its four sides are individually aligned or coincident with the four sides of the mounting surface 11. The protrusions 70a and 70b that are on the mounting surface 11 are located in the openings 72a and 72b of the board 12, respectively. The connector 71 that is mounted on the control circuit board 12 is connected to the connector of the substrate unit 34.

The notch portions 77 at the four corners of the control circuit board 12 are situated individually in the four corner portions of the mounting surface 11. Thus, the four corner portions of the mounting surface 11 are exposed to the outside without being covered by the board 12. Corner portions of the case 10 including the four exposed corner portions of the mounting surface 11 individually constitute holding portions 78, whereby the case can be held without any touching the board 12.

According to the HDD constructed in this manner, the control circuit board 12 is provided with the connector pads 80 for connection with external equipment. The connector pads are exposed on the outer surface of the control circuit board. The HDD can be connected directly to the external equipment through the pads 80. Therefore, the connector that is relatively bulky may be omitted, and the whole HDD including the control circuit board 12 can be reduced in thickness. Thus, a smaller HDD can be obtained that is usable as a recording device for a wider variety of electronic apparatuses.

The card-type portable HDD constructed in this manner may be used as a recording device for any of various electronic apparatuses, such as a portable telephone, digital camera, video camera, personal digital assist (PDA), etc.

According to the HDD described above, moreover, the first and second shells 10a and 10b that constitute the case 10 are supported opposite to each other with a gap between them by the support posts 18 on one of the shells. If any external force acts on the case 10, therefore, the case 10 and the components therein can be prevented from being damaged. With use of the support posts 18, moreover, screw points between the shells 10a and 10b can be reduced in number, so that the ease of assembly and maintainability of the device can be improved.

In the embodiment described above, the connector pads 80 of the control circuit board 12 are arranged in a line. However, the number and arrangement of connector pads may be variously changed as required or depending on the external equipment to be connected. According to a second embodiment shown in FIG. 7, a plurality of connector pads 80 of a control circuit board 12 are arranged along one short side of the board 12. Among the connector pads 80, a pad 80a which is situated at one end of the pad array is deviated from the other pads with distance from the short side of the board 12.

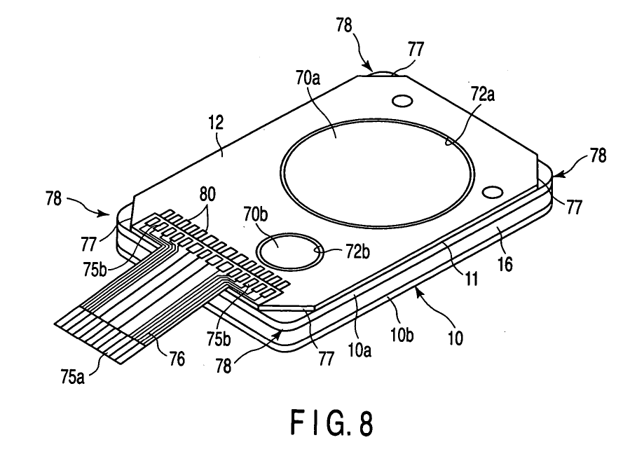

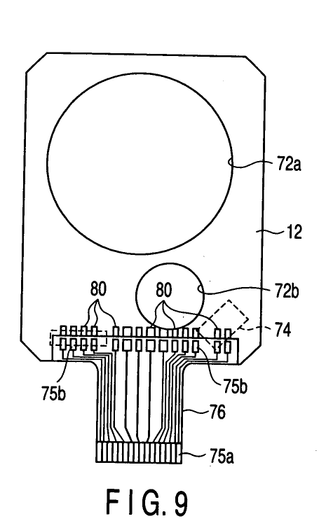

The HDD may be provided with a connector cable that extends from the control circuit board 12. In an HDD according to a third embodiment of the invention, as shown in FIGS. 8 and 9, a control circuit board 12 is connected with a flexible printed circuit board 76 having pad connectors 75a at a distal end thereof and pad connectors 75b at an end proximate to the control circuit board 12. The flexible printed circuit board 76 may be used for electrical connection between the HDD and external equipment. The circuit board 76 that functions as a connector cable is drawn out through one short side of the board 12. The distal connector pads 75b are used for connection with the external equipment.

The proximal end portion of flexible printed circuit board 76 having the pad connectors 75b is connected to the control circuit board 12 so as to cover about half the total area of connector pads 80 and is connected electrically to the pads 80. Thus, as seen in FIGS. 8 and 9, about half of the pads 80 are exposed and about half are covered by the overlying pad connectors 75b.

According to the third embodiment arranged in this manner, the HDD can be connected to the external equipment through the flexible printed circuit board 76. Since half of the connector pads 80 are exposed, moreover, the HDD can be connected to the external equipment also by directly using the pads 80. If the pads 80 are used by direct connection thereto of the external equipment, the flexible circuit board 76 need not be used even thought it may remain physically connected to the other half of the pads 80. Thus, according to the present embodiment, the flexible printed circuit board 76 or the connector pads 80 may be alternatively used depending on the external equipment to be connected, so that the range of application of the HDD can be further enlarged. The third embodiment can produce the same function and effect as those of the foregoing first embodiment.

The other parts of the second and third embodiments are the same as those of the first embodiment. Therefore, like reference numerals are used to designate like portions of the three embodiments, and a detailed description of those portions is omitted.

The present invention is not limited directly to the embodiments described above, and various changes or modifications may be effected therein without departing from the scope or spirit of the invention. Further, various inventions may be made by suitably combining a plurality of components described in connection with the foregoing embodiments. For example, some of the components according to the foregoing embodiments may be omitted. Furthermore, the components according to the different embodiments may be combined as required.

For example, the number of heads, as well as the number of magnetic disks to be held in the device, may be varied as required. The diameter of each magnetic disk is not limited to 0.85 inches, and may alternatively be adjusted to 1.8 or 2.5 inches.

1. A disk drive comprising:
a case;
a disk-shaped recording medium located in the case;
a drive motor which is located in the case and supports and rotates the recording medium;
a head which processes information for the recording medium;
a head actuator which is disposed in the case, supports the head for movement, and moves the head with respect to the recording medium;
a substrate unit, including electronic components for use with said head, disposed in the case and electrically connected to the head; and
a control circuit board mounted to the outer surface of the case and electrically connected to the substrate unit,
the control circuit board having a plurality of connector pads for connection with external equipment, the connector pads being arranged side by side and exposed on the outer surface of the control circuit board, said plurality of connector pads being positioned on a side of said control circuit board adjacent said head actuator.

2. A disk drive according to claim 1, wherein the case has a substantially rectangular shape and control circuit board is formed having a substantially rectangular shape corresponding to the outer surface of the case, and the plurality of connector pads are arranged side by side along one side of the control circuit board.

3. A disk drive according to claim 2, wherein the head actuator has a bearing portion and an arm which is rotatably supported by the bearing portion and supports the head, the drive motor and the bearing portion are arranged side by side in the longitudinal direction of the case, and the connector pads are arranged side by side along a short side of the control circuit board which is situated on a side of the case containing the bearing portion.

4. A disk drive according to claim 2, wherein at least one of the plurality of connector pads which is situated at one end of the plurality of connector pads is positioned on the control circuit board at a greater distance from the one side than other connector pads of said plurality of connector pads.

5. A disk drive according to claim 1, which further comprises a connector cable which extends from the control circuit board and has a connector terminal on a distal end thereof, the proximal end portion of the connector cable being connected to the plurality of connector pads to overlap portions of said plurality of connector pads such that other portions of said plurality of connector pads are exposed.

6. A disk drive according to claim 1, wherein the case and the control circuit board each have a rectangular shape and each have a longitudinal dimension of about 32 mm and a crosswise dimension of about 24 mm, and the total thickness of the case and the control circuit board ranges from about 3 to 6 mm.

7. A disk drive according to claim 1, wherein the recording medium has a diameter of 0.85 inches.

8. A disk drive comprising:
a case;
a disk-shaped recording medium located in the case;
a drive motor which is located in the case and supports and rotates the recording medium;
a head which processes information for the recording medium;
a head actuator which is disposed in the case, supports the head for movement, and moves the head with respect to the recording medium; and
a control circuit board mounted to the outer surface of the case and electrically connected through the case at least to the head,
the control circuit board having a plurality of connector pads for connection with external equipment, the connector pads being arranged side by side and exposed on the outer surface of the control circuit board, said plurality of connector pads positioned on a side of said control circuit board adjacent said head actuator.

9. A disk drive according to claim 8, wherein the case has a substantially rectangular shape and control circuit board is formed having a substantially rectangular shape corresponding to the outer surface of the case, and the plurality of connector pads are arranged side by side along one side of the control circuit board.

10. A disk drive according to claim 9, wherein the head actuator has a bearing portion and an arm which is rotatably supported by the bearing portion and supports the head, the drive motor and the bearing portion are arranged side by side in the longitudinal direction of the case, and the connector pads are arranged side by side along a short side of the control circuit board which is situated on a side of the case containing the bearing portion.

11. A disk drive according to claim 9, wherein at least one of the plurality of connector pads which is situated at one end of the plurality of connector pads is positioned on the control circuit board at a greater distance from the one side than other connector pads of said plurality of connector pads.

12. A disk drive according to claim 8, which further comprises a connector cable which extends from the control circuit board and has a connector terminal on a distal end thereof, the proximal end portion of the connector cable being connected to the plurality of connector pads to overlap portions of said plurality of connector pads such that other portions of said plurality of connector pads are exposed.

13. A disk drive according to claim 8, wherein the case and the control circuit board each have a rectangular shape and each have a longitudinal dimension of about 32 mm and a crosswise dimension of about 24 mm, and the total thickness of the case and the control circuit board ranges from about 3 to 6 mm.

14. A disk drive according to claim 8, wherein the recording medium has a diameter of 0.85 inches.
